(19) United States
(12) Patent Application Publication
(10) Pub. No.: US 2012/0061939 A1
(43) Pub. Date: Mar. 15, 2012

(54) WHEEL CHAIR WITH A MANUAL DEVICE TO GIVE HIM/HER A BETTER MOBILITY

(76) Inventors: Jorge Ivan Diaz-Ortiz, Miami, FL (US); Jose Guillermo Ortiz-Perez, Bogata D.C. (CO)

(21) Appl. No.: 12/302,532

(22) PCT Filed: Mar. 9, 2007
(86) PCT No.: PCT/IB07/01342

§ 371 Date: Sep. 30, 2009

(30) Foreign Application Priority Data
May 30, 2006 (CO) 06-1587

(51) Int. Cl. B62M 1/14

(52) U.S. Cl. 280/246

(57) ABSTRACT

The present invention is a wheelchair with a pair of levers on either side that actuate a reciprocating gear-ratchet assembly for moving the wheelchair when the levers are moved.

### INDEX TO RELATED APPLICATIONS

This application claims the benefit of PCT application PCT/IB2007/001342 filed Mar. 9, 2007, which claims the benefit of Colombian Patent Application No. 06-051587 filed May 30, 2006, the disclosures of which are incorporated herein by reference in their entirety.

### BACKGROUND OF THE INVENTION

The traditional wheelchair had its origin from the necessity of providing mobility for persons unable to walk. Electrical and motor driven wheelchairs exist. However, a vast majority of wheelchairs in use today are operated without the benefit of drive motors. There is a need to increase the mechanical advantage from the force expended by a person in a wheelchair and to translate this force into a more efficient energy to move a wheelchair.

### BRIEF SUMMARY OF THE INVENTION

In one embodiment, the present invention is a wheelchair having:

a. a gear plate attached to a pair of rear wheelchair wheels, with a plurality of gear teeth circumferally about the edge of said gear plate;

b. a lever pivotably attached to the gear plate; and

c. a ratchet mechanism attached to said lever.

The gear plate is constructed and arranged to rotate on each of a pair of rear wheels on a wheelchair. The gear plate rotates freely as each wheel rotates when the chair is moved. When a user desires to move the chair, they push forward on a lever on either side of the wheelchair. The lever is connected to an actuating mechanism that causes a ratchet assembly releasably engage gear teeth on the gear plate.

When the lever is retracted towards a person in said wheelchair and subsequently extended forward away from a person sitting in the wheelchair, ratchet mechanism engages the gear teeth on the gear plate and the motion of pushing the lever forward imparts forward force on the gear assembly, thus moving the wheelchair forward.

The mechanism for actuating the ratchet mechanism is disengaged when the lever is retracted from an extended position and the lever is moved towards a person sitting in the wheelchair.

The gear plate rotates with the rear wheels about an axel. In one embodiment, the gear plate shares the same axel as the rear wheels. In an alternative embodiment, the gear plate has a separate axel from the axel that is used in rotation of the rear wheels.

The reciprocating process of repeatedly engaging and disengaging the ratchet mechanism on the gears results in rotation of the rear wheelchair wheels.

In one embodiment, the wheelchair has at least two gear plates with a first gear plate constructed and arranged to move the wheelchair forward and a second gear plate constructed and arranged to move the wheelchair backward.

In the embodiment with two gear plates, the lever is constructed and arranges with an actuator that is user changeable to impart either a forward or backward motion on the wheelchair.

The present invention is also a method of moving a wheelchair having the steps of:

a. providing a wheelchair according to the present invention;

b. sitting a person in said wheelchair;

c. moving said lever into a retracted position towards said user;

d. extending said lever outward from said user;

e. releasing said level from said extending of said level;

f. allowing rear wheels to rotate.

The method provides that repeating the steps of extending and retracting the lever impart a reciprocating ratchet gear engagement/disengagement that imparts motion on the gear plates and rear wheels of the wheelchair.

### BRIEF DESCRIPTION OF THE DRAWINGS

FIG. 1 is a perspective view of the wheelchair.

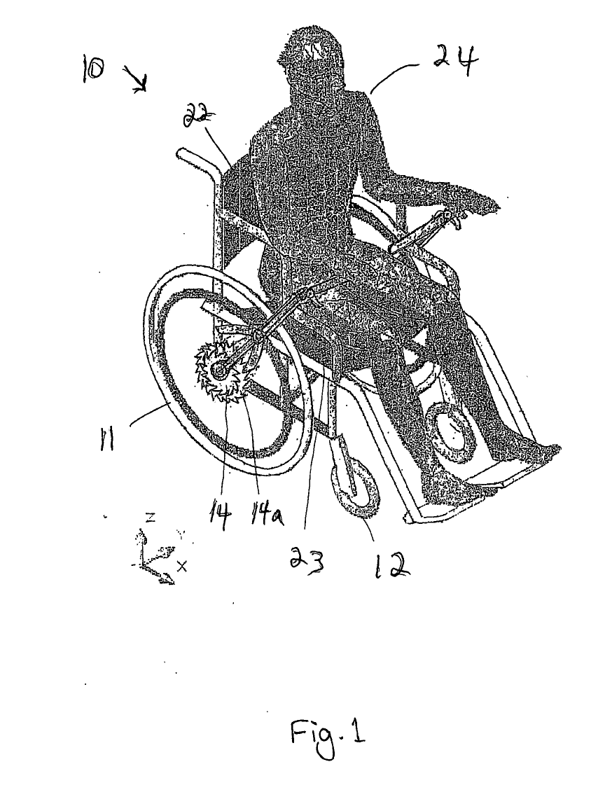

FIG. 2 is a side view of the wheelchair with a person sitting thereon.

FIG. 3 is a side view of the wheelchair.

FIG. 4 is a perspective view of the wheelchair.

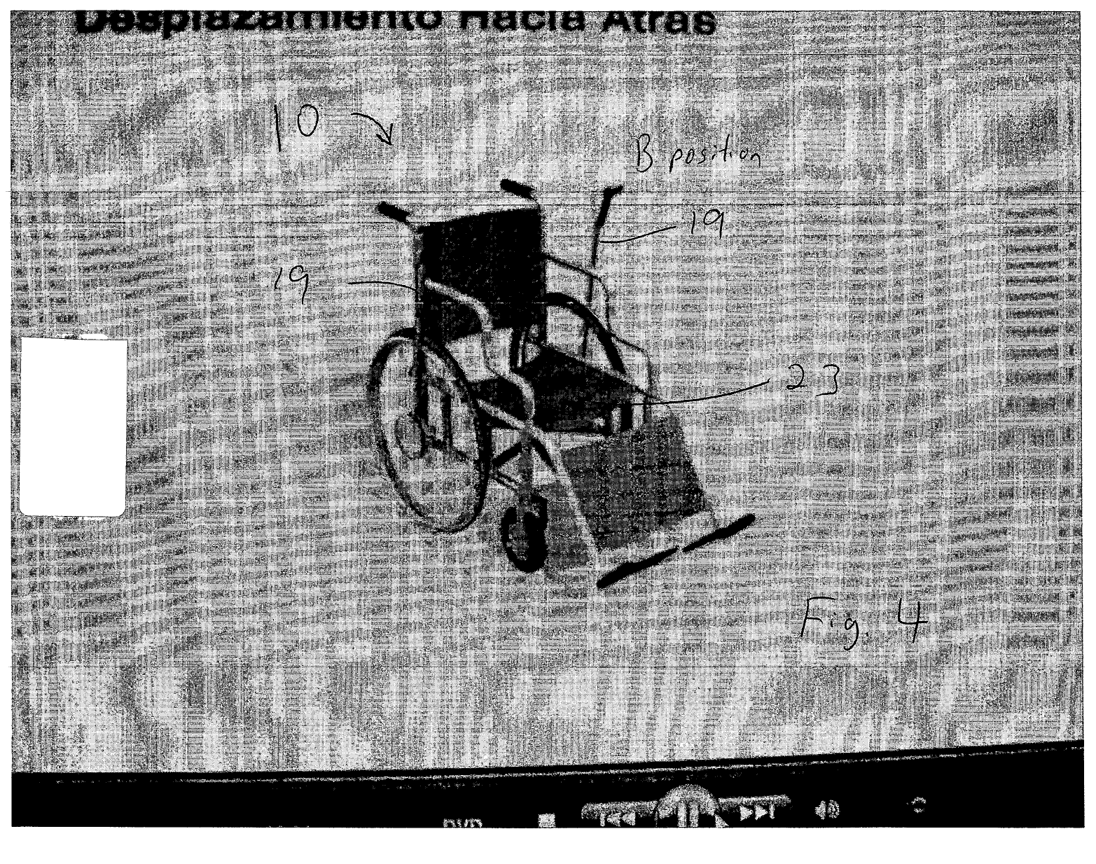

FIG. 5 is a perspective view of the wheelchair.

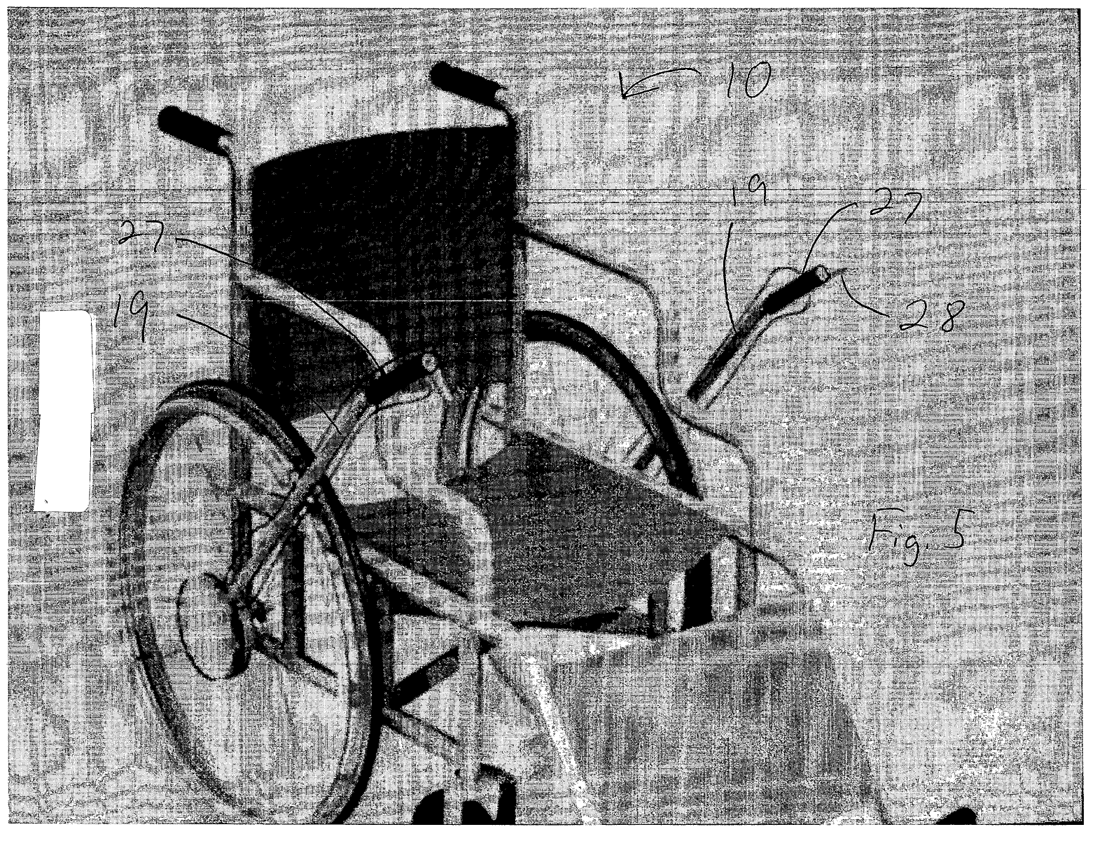

FIG. 6 is a close up of the handle region of one lever of the wheelchair with drive direction mechanism in a reverse position.

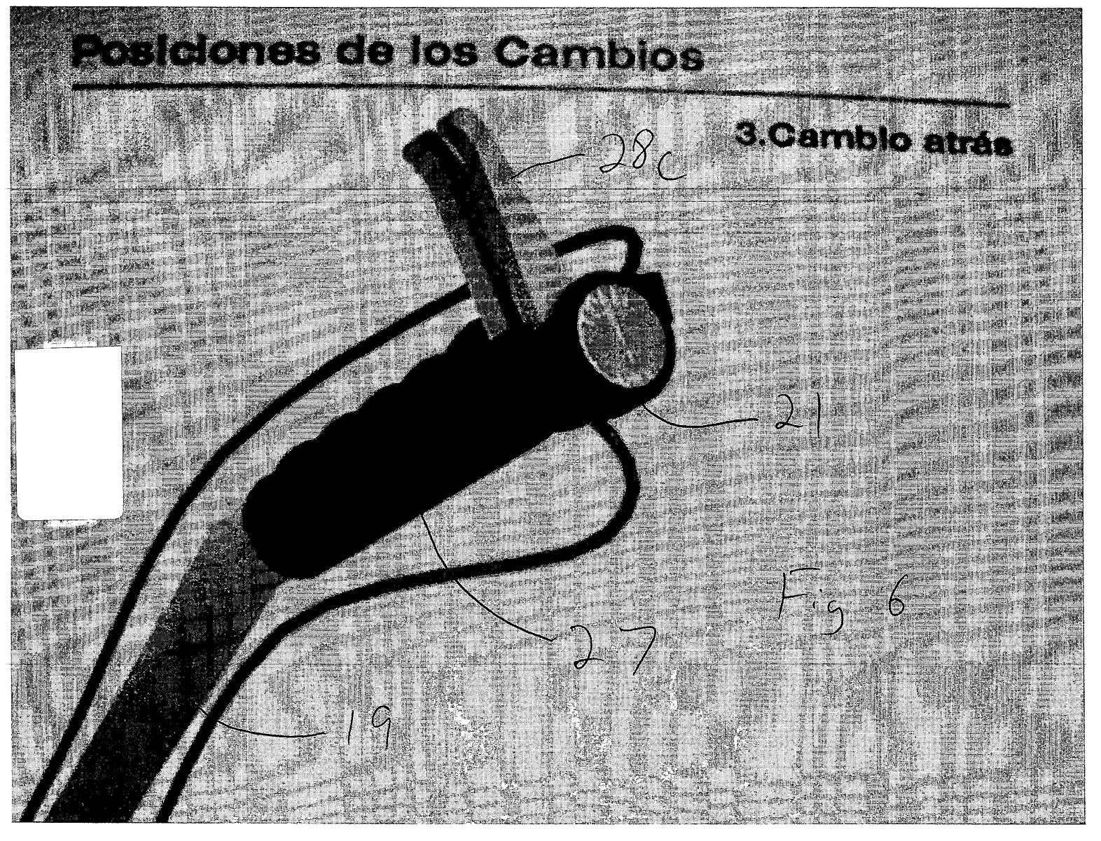

FIG. 7 is a close up of the handle region of one lever of the wheelchair with drive direction mechanism in a neutral position.

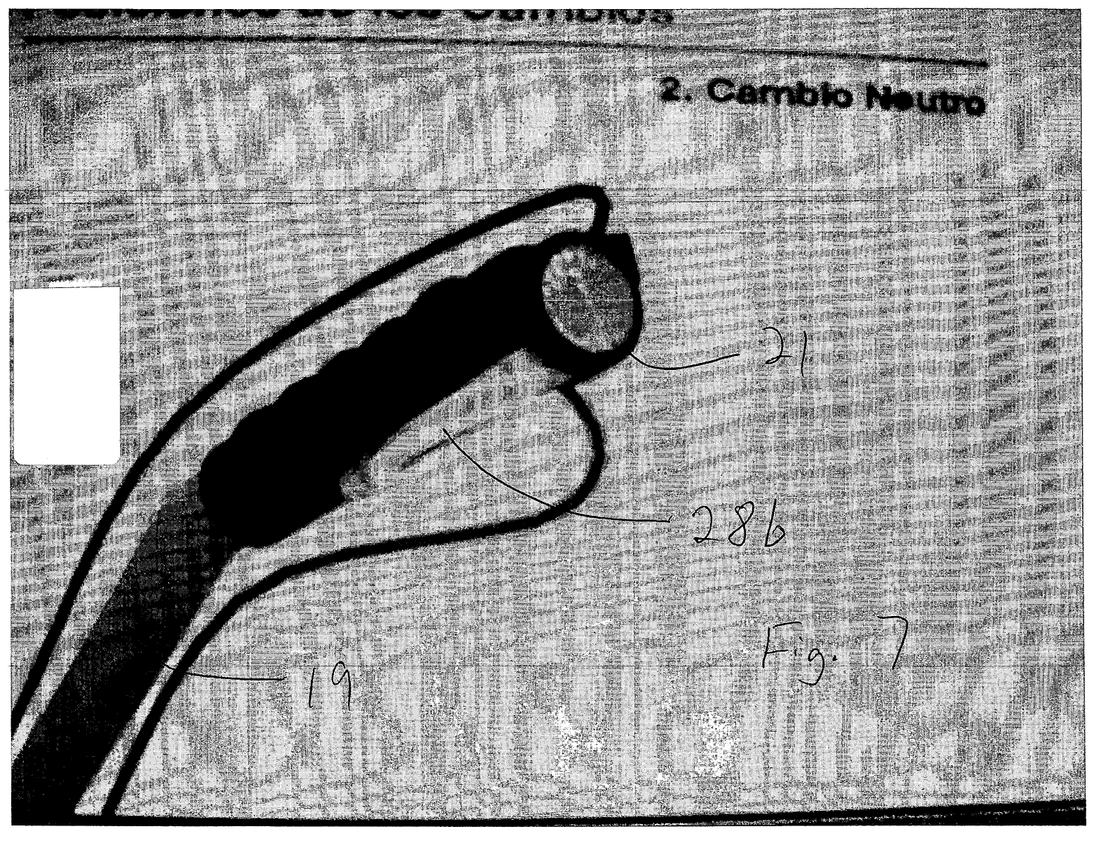

FIG. 8 is a close up of the handle region of one lever of the wheelchair with drive direction mechanism in a forward position.

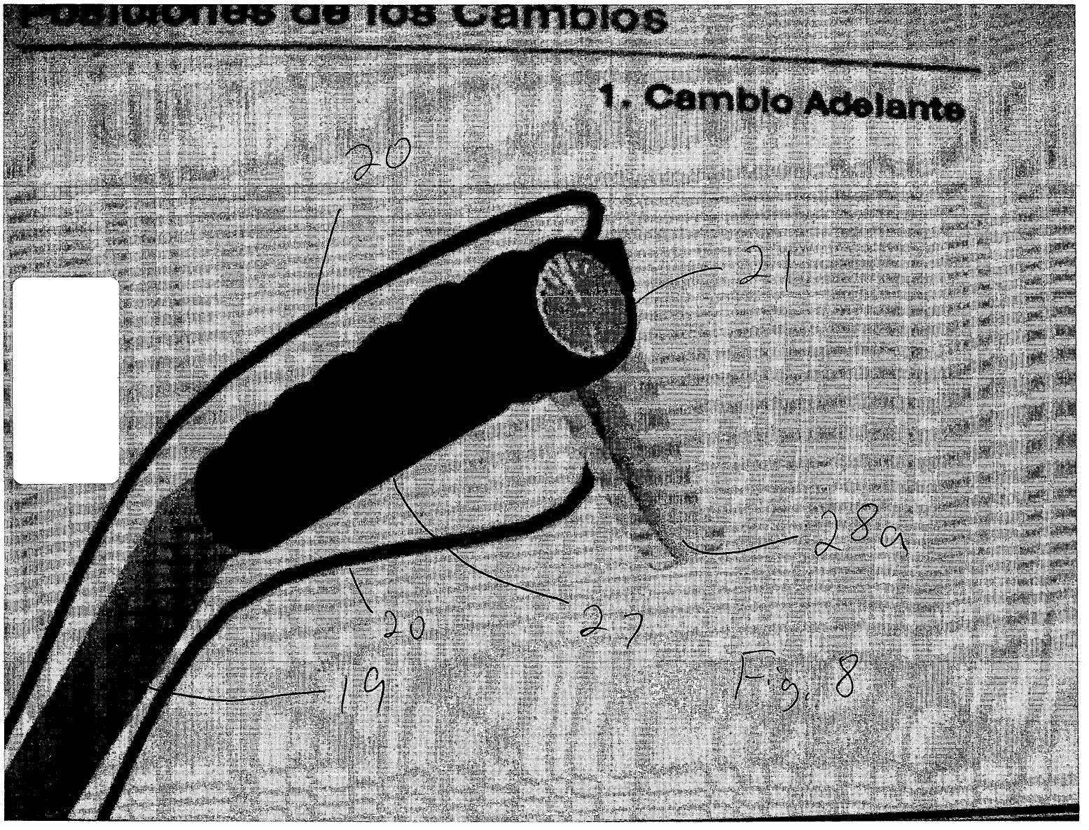

FIG. 9 is a perspective view of the wheelchair showing one drive direction mechanism in a forward position (28a) and a second drive mechanism in a neutral position (28c) arranged for driving one rear wheel and subsequently turning the wheelchair.

### DETAILED DESCRIPTION OF THE PREFERRED EMBODIMENTS

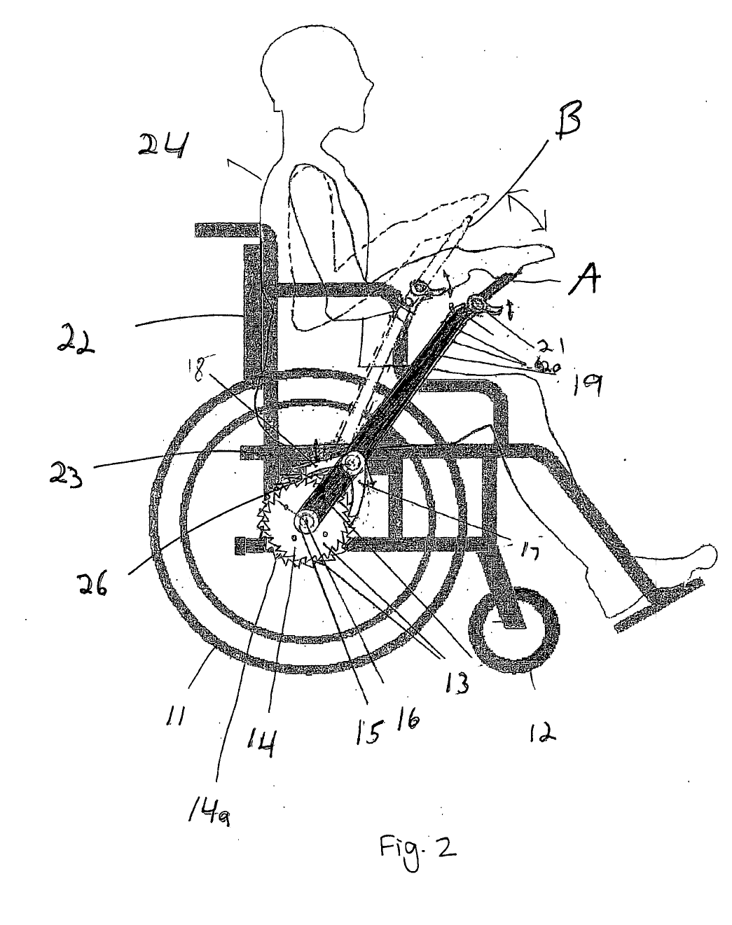

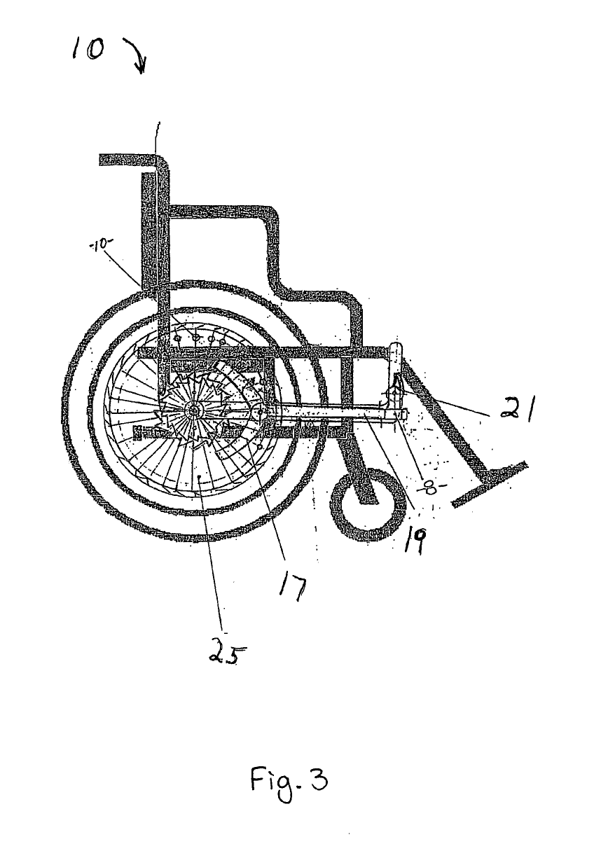

The present invention is a wheelchair 10, with a back portion 22, a seat portion 23, for supporting a person 24. Wheelchair 10 has a pair of rear wheels 11 and a pair of front wheels 12, as are commonly known in the art. Each of rear wheels 11 have identical assemblies as depicted in FIGS. 2 and 3. Gear plate 14 has gear teeth 13 positioned about the outer circumference of gear plate 14. Gear teeth 13 are constructed and arranged to interact with a first ratchet 17 and a second ratchet 18 that are mounted on lever 19 near plate 14 at lower ratchet actuator 26. Lever 19 is pivotably attached at axel 16 centrally positioned on plate bearing 15. Lever 19 is moved by person 24 into either retracted position B or extended position A. Lever 19 has gear wires 20 that are mechanically actuated by lever bearing assembly 21.

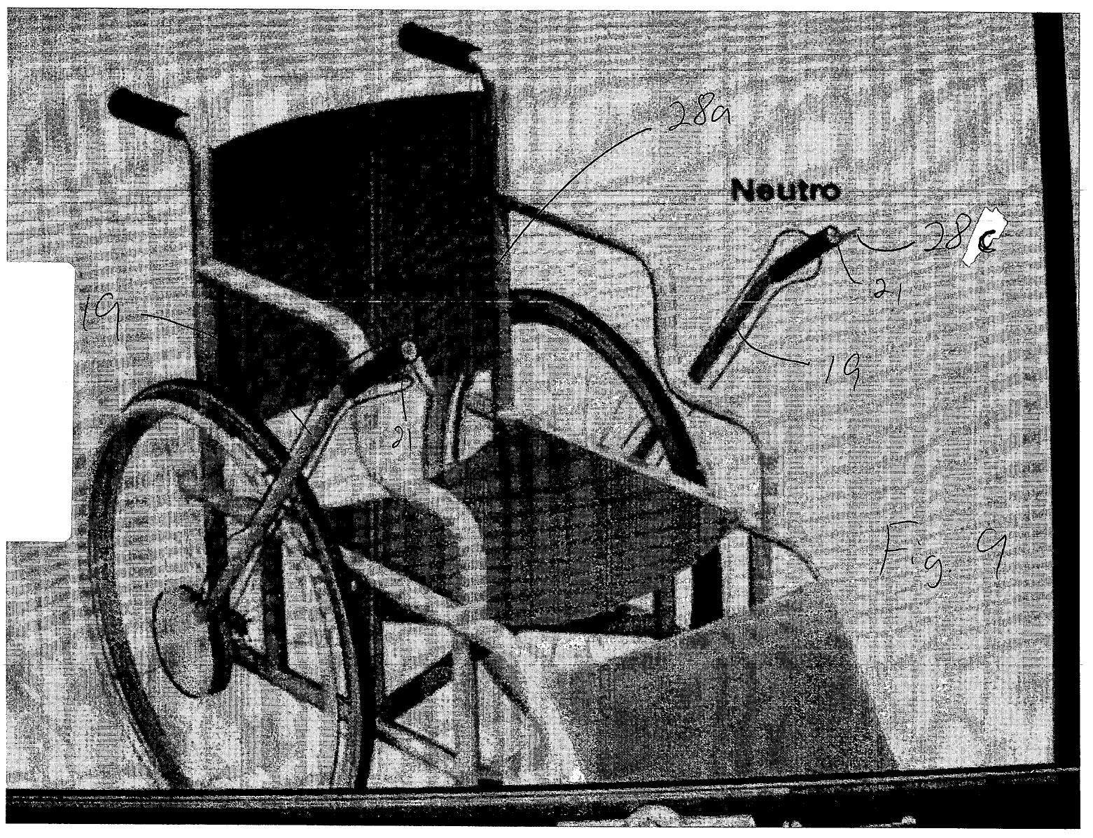

In one embodiment, lever bearing assembly 21 is on handle 27 of lever 19. Direction actuator 28 is identified in the Figs. with letter indications to indicate position, is movable and is moved in position 28a to impart forward motion, 28c to impart reverse motion, and 28b to disengage the drive-ratchet assembly into a neutral position in which no motion is imparted to rear wheels 11. As shown in FIG. 9, each of direction actuators 28a and 28b may be in different positions. In this configuration, only the rear wheel 11 associated with direction actuator in 28 a will move forward. Rear wheel 11 associated with direction actuator 28c will not move when lever 19 is moved because 28c indicates a neutral position. Thus, when only one rear wheel moves, wheelchair 10 turns. Wheelchair 10 turns using only a single lever 19, or turns using one lever 19 engaged in a drive position 28a or 28b, and the opposite lever disengaged as in 28c.

Wheelchair 10 has a cover 25 that covers gear plate 14.

When a person 24 retracts lever 19 into position B, each of first ratchet 17 and second ratchet 18 disengage from gear teeth 13 and on gear plate 14. When lever 19 is pushed forward such that lever 19 is in extended position A, lever bearing 21 imparts tension on gear wires 20. The tension on gear wires 20 pulls each of first ratchet 17 and second ratchet 18 into position such that the end of each of first ratchet 17 and second ratchet 18 contact a position between gear teeth 13. First ratchet 17 and second ratchet 18 become rigid about lower ratchet mechanism 26 by virtue of tension imparted by gear wire 20. When lever 19 is pushed forward, the fixed position of first ratchet 17 in second ratchet 18 gear teeth 13 attached to wheel plate 14 rotates wheel plate 14 and subsequently rotate each of rear tires 11.

When person 24 releases lever 19, first ratchet 17 in second ratchet 18 releases, or disengages from gear teeth 13 and each of rear tires 11 roll freely.

In one embodiment, wheelchair 10 has two gear plates 14 and 14a. The user can engage an actuator in lever 19 in order to impart rearward motion on wheelchair 10.

The ratchet and moving mechanism described herein is constructed and arranged to be affixed to a conventional wheelchair.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

1-8. (canceled)

9. A wheelchair comprising:
a. a gear plate attached to a pair of rear wheelchair wheels, with a plurality of gear teeth circumferally about the edge of said gear plate;
b. a lever pivotably attached to the gear plate; and
c. a ratchet mechanism attached to said lever.

10. The wheelchair of claim 9 wherein said gear plate is constructed and arranged to rotate with a pair of large rear wheels on a wheelchair.

11. The wheelchair of claim 9 wherein said lever comprises a mechanism for actuating said ratchet mechanism.

12. The wheelchair of claim 9 wherein said ratchet mechanism is constructed and arranged to releasably engage said gear teeth.

13. The wheelchair of claim 9 wherein said lever is retracted towards a person in said wheelchair and subsequently extended away from a person in said wheelchair.

14. The wheelchair of claim 11 wherein said mechanism for actuating said ratchet mechanism is engaged when said lever is extended outward from a person sitting in said wheelchair.

15. The wheelchair of claim 11 wherein said mechanism for actuating said ratchet mechanism is disengaged when said lever is retracted from an extended position toward from a person sitting in said wheelchair.

16. The wheelchair of claim 14 wherein said engagement of said mechanism for actuation rotates said gear plate and attached rear wheels about an axel.

17. The wheelchair of claim 15 wherein said disengaged mechanism results in rotation of said rear wheelchair wheels.

18. The wheelchair of claim 9 comprising at least two gear plates with a first gear plate constructed and arranged to move said wheelchair forward and a second gear plat constructed and arranged to move said wheelchair backward.

19. A method of moving a wheelchair comprising the steps of:
a. providing a wheelchair according to claim 1;
b. sitting a person in said wheelchair;
c. moving said level into a retracted position towards said user;
d. extending said lever outward from said user;
e. releasing said level from said extending of said level;
f. allowing rear wheels to rotate.
